(19) United States
(12) Patent Application Publication
(10) Pub. No.: US 2025/0358192 A1
(43) Pub. Date: Nov. 20, 2025

(54) RESOURCE EXCHANGE AUCTION SYSTEM

(71) Applicant: GM Global Technology Operations LLC, Detroit, MI (US)

(72) Inventors: Paolo Giusto, Brentwood, CA (US); Venkata Naga Siva Vikas Vemuri, Farmington Hills, MI (US); Arun Adiththan, Sterling Heights, MI (US); Lakshmi V. Thanayankizil, Troy, MI (US); Mohamed A. Layouni, Fraser, MI (US); Angelos Angelopoulos, Carrboro, NC (US)

(73) Assignee: GM Global Technology Operations LLC, Detroit, MI (US)

(21) Appl. No.: 18/666,367

(22) Filed: May 16, 2024

(51) Int. Cl. H04L 41/0896; G06Q 30/08

(52) U.S. Cl. CPC H04L 41/0896; G06Q 30/08

(57) ABSTRACT

A computer-implemented method when executed by data processing hardware causes the data processing hardware to perform operations. The operations include initiating, at a first ecosystem, a request, the first ecosystem being one of a donor and a requestor, discovering, by a second ecosystem, the initiated request, the second ecosystem being the other of the donor and requestor, and executing, at one of a first ecosystem and a second ecosystem, a resource exchange auction protocol (REAP). The REAP includes controlling access to resources, assessing the other of the first ecosystem and the second ecosystem, selecting the other of the first ecosystem and the second ecosystem, and sharing the resources of one of the first ecosystem and the second ecosystem with the other of the first ecosystem and the second ecosystem.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a resource exchange auction system for use between two or more ecosystems.

Many ecosystems are equipped with communication resources (e.g., available bandwidth) that are used by various devices connected as part of a respective ecosystem. For example, a vehicle ecosystem may include a vehicle that communicates with a charging station via the data resources via a cloud network. However, ecosystems typically have a limit or cap of data resources, such that there may be insufficient data resources available to execute the communications between devices. The depletion of data resources may result in an ecosystem becoming inactive or having certain functionalities be unavailable until the data resources are replenished. Thus, there is a need for improved data resource sharing between ecosystems where a data resource surplus may be available.

### SUMMARY

In some aspects, a computer-implemented method when executed by data processing hardware causes the data processing hardware to perform operations. The operations include initiating, at a first ecosystem, a request, the first ecosystem being one of a donor and a requestor, discovering, by a second ecosystem, the initiated request, the second ecosystem being the other of the donor and requestor, and executing, at one of the first ecosystem and the second ecosystem, a resource exchange auction protocol (REAP). The REAP includes controlling access to resources, assessing the other of the first ecosystem and the second ecosystem, selecting the other of the first ecosystem and the second ecosystem, and sharing the resources of one of the first ecosystem and the second ecosystem with the other of the first ecosystem and the second ecosystem.

In some examples, assessing the other of the first ecosystem and the second ecosystem may include scoring the other of the first ecosystem and the second ecosystem with a bidder network scoring of the REAP. In some configurations, an internet-of-things (IoT) controller may be configured to execute the REAP, and the IoT controller may be in communication with a first ecosystem controller and a second ecosystem controller. Optionally, the first ecosystem may be a requestor and initiating the request may include notifying, by the IoT controller, the first ecosystem of a resource surplus of the second ecosystem. In some instances, the first ecosystem may be a donor and initiating the request may include notifying, by the IoT controller, the second ecosystem of a resource surplus of the first ecosystem.

The IoT controller may be configured to execute the REAP based on a request from the second ecosystem to access the resource surplus of the first ecosystem. Optionally, the REAP may include admission control logic and controlling access to the resources includes executing the admission control logic. In some examples, executing the REAP may include executing a reverse auction. Additionally or alternatively, executing the REAP includes executing a true auction.

In other aspects, a system includes data processing hardware and memory hardware in communication with the data processing hardware. The memory hardware stores instructions that when executed on the data processing hardware cause the data processing hardware to perform operations. The operations include initiating, at a first ecosystem, a request, the first ecosystem being one of a donor and a requestor, discovering, by a second ecosystem, the initiated request, the second ecosystem being the other of the donor and requestor, and executing, via one of the first ecosystem and the second ecosystem, a resource exchange auction protocol (REAP). The REAP includes controlling access to resources, assessing the other of the first ecosystem and the second ecosystem, selecting the other of the first ecosystem and the second ecosystem, and sharing the resources of one of the first ecosystem and the second ecosystem with the other of the first ecosystem and the second ecosystem.

In some examples, assessing the other of the first ecosystem and the second ecosystem may include scoring the other of the first ecosystem and the second ecosystem with a bidder network scoring of the REAP. In some configurations, an internet-of-things (IoT) controller may be configured to execute the REAP, the IoT controller may be in communication with a first ecosystem controller and a second ecosystem controller. Optionally, the first ecosystem may be a requestor and initiating the request may include notifying, by the IoT controller, the first ecosystem of a resource surplus of the second ecosystem. In some instances, the first ecosystem may be a donor and initiating the request may include notifying, by the IoT controller, the second ecosystem of a resource surplus of the first ecosystem.

The IoT controller may be configured to execute the REAP based on a request from the second ecosystem to access the resource surplus of the first ecosystem. Optionally, the REAP may include admission control logic and controlling access to the resources may include executing the admission control logic. In some examples, executing the REAP may include executing a reverse auction. Additionally or alternatively, executing the REAP includes executing a true auction.

In further aspects, a computer-implemented method when executed by data processing hardware causes the data processing hardware to perform operations. The operations include initiating, at a first ecosystem, a request, the first ecosystem being one of a donor and a requestor, discovering, by a second ecosystem, the initiated request, the second ecosystem being the other of the donor and requestor, and executing, at one of the first ecosystem and the second ecosystem, a resource exchange auction protocol (REAP), the REAP including admission control logic. Executing the REAP includes controlling access to resources via the admission control logic, scoring the first ecosystem with a bidder network scoring of the REAP, selecting the other of the first ecosystem and the second ecosystem, and sharing the resources of one of the first ecosystem and the second ecosystem with the other of the first ecosystem and the second ecosystem.

Optionally, a vehicle may include a controller configured to execute the above method.

### BRIEF DESCRIPTION OF THE DRAWINGS

The drawings described herein are for illustrative purposes only of selected configurations and are not intended to limit the scope of the present disclosure.

FIG. 1 is a schematic of a first vehicle ecosystem of a resource exchange auction system according to the present disclosure, the first vehicle ecosystem in communication with a back office server and an internet-of-things data store;

FIG. 2 is another schematic of a resource exchange auction system according to the present disclosure, the resource exchange auction system including a first vehicle ecosystem in communication with a second vehicle ecosystem and a back office server;

FIG. 3 is an exemplary block diagram of a resource exchange auction system according to the present disclosure;

FIG. 4 is another exemplary block diagram of a resource exchange auction system according to the present disclosure;

FIG. 5 is a schematic of a first ecosystem of a resource exchange auction system receiving a request from a second ecosystem of the resource exchange auction system according to the present disclosure;

FIG. 6 is a schematic of a first ecosystem of a resource exchange auction system issuing a request to a second ecosystem of the resource exchange auction system according to the present disclosure;

FIG. 7 is an exemplary flow diagram of a true auction of a resource exchange auction system according to the present disclosure; and

FIG. 8 is an exemplary flow diagram of a reverse auction of a resource exchange auction system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

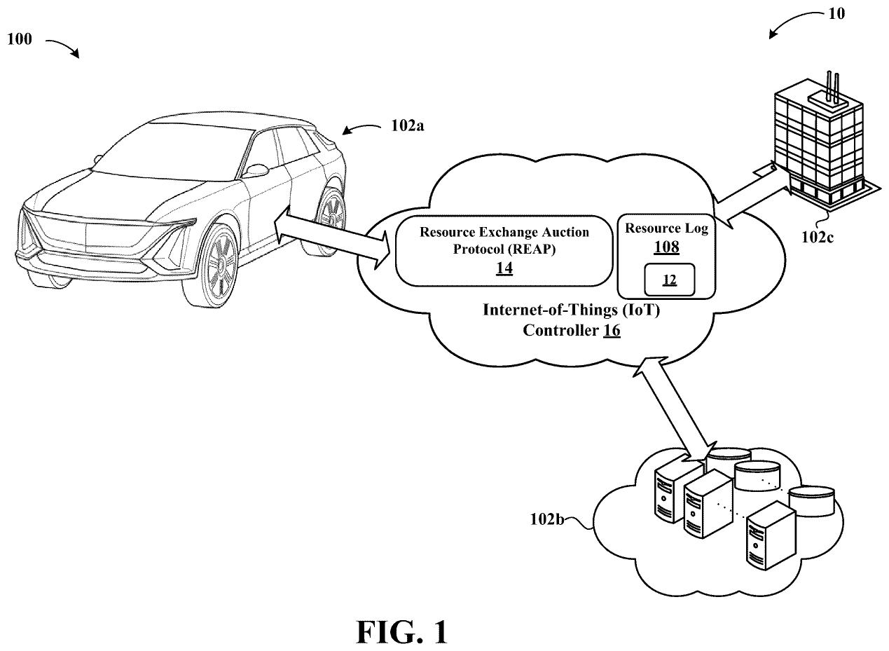

Referring to FIGS. 1-3, a resource exchange auction system 10 is configured to exchange and direct resources 12 between a first ecosystem 100 and a second ecosystem 200. As described herein, the ecosystems 100, 200 are related to various vehicle ecosystems. However, it is also contemplated that the ecosystems 100, 200 may be configured as any ecosystem that utilizes resources 12 to execute various functions of the ecosystems 100, 200. For example, the ecosystems 100, 200 may include, but are not limited to, vehicle-to-cloud/edge, road side units (RSUs)-to-cloud, smart chargers-to-cloud, etc. The resources 12 may include, but are not limited to, bandwidth, computational, processing, communications, etc. The resource exchange auction system 10 is configured to interconnect an ecosystem 100, 200, 200a-n that has a surplus of resources 12 with an ecosystem 200 that has a deficit of resources 12. For example, the resource exchange auction system 10 is configured to govern end-to-end sharing of resources 12 from one ecosystem donor to an ecosystem receiver.

The resource exchange auction system 10 is configured to facilitate a resource exchange auction protocol (REAP) 14 via an internet-of-things (IoT) controller 16 configured to communicate with a controller 102, 202 of each respective ecosystem 100, 200. For example, the ecosystems 100, 200 may be configured with a network of controllers, and the IoT controller 16 is designed to execute the REAP 14 between each of the ecosystems 100, 200.

For description purposes, the features described with respect to the first ecosystem controller 102 may also be configured as part of the second ecosystem controller 202, such that the reference numerals used in association with the first ecosystem controller 102 may be understood to be incorporated by the second ecosystem controller 202 with the addition of one-hundred (100). It is also contemplated that the reference numerals used for the second ecosystem 200 substantially incorporate additional ecosystems 200a-n that may be operable within the resource exchange auction system 10, such that the same reference numerals may be used with a letter extension.

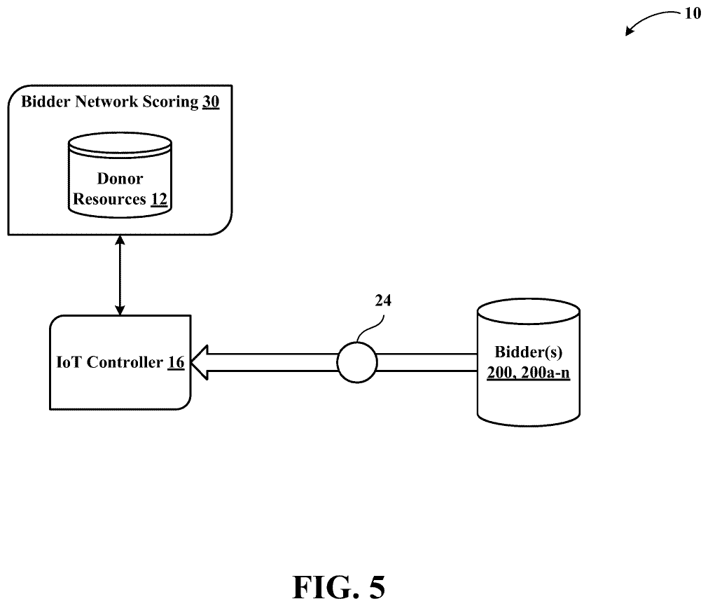

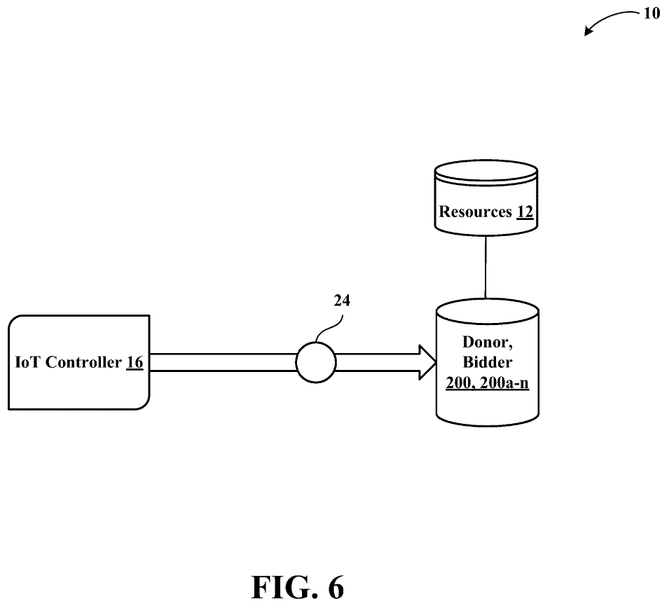

The REAP 14 may be configured as a true auction 18 (FIG. 5) or a reverse auction 20 (FIG. 6), described herein, and is executed by data processing hardware 104 of the IoT controller 16. The IoT controller 16 also includes memory hardware 106 in communication with the data processing hardware 104. The memory hardware 106 stores instructions that, when executed on the data processing hardware 104, cause the data processing hardware 104 to perform operations, set forth herein. The memory hardware 106 also stores a resource log 108 of the respective resources 12 of the first ecosystem 100. The resource log 108 may store a resource deficit 22 and a resource surplus 24 based on the resources 12 available to the respective ecosystem 100. The resource log 108 may also store the resources 12.

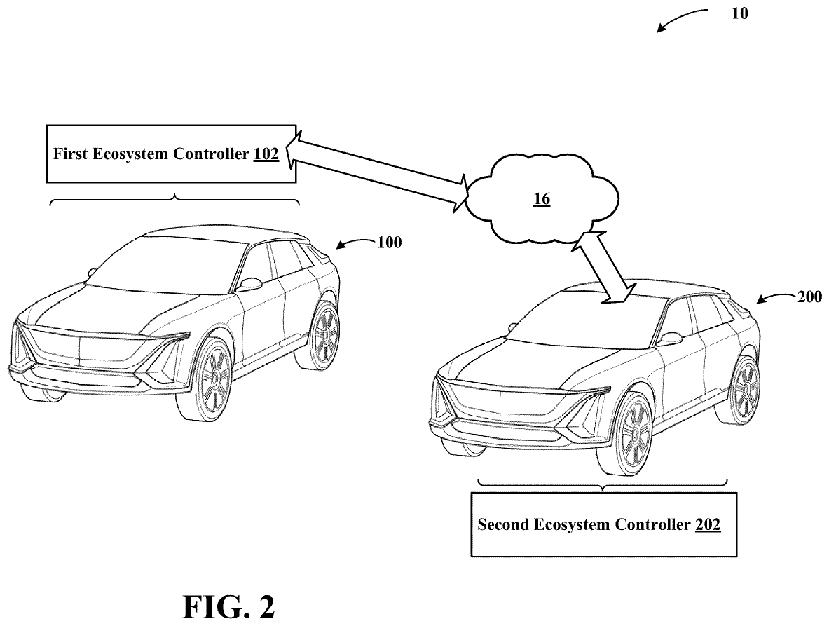

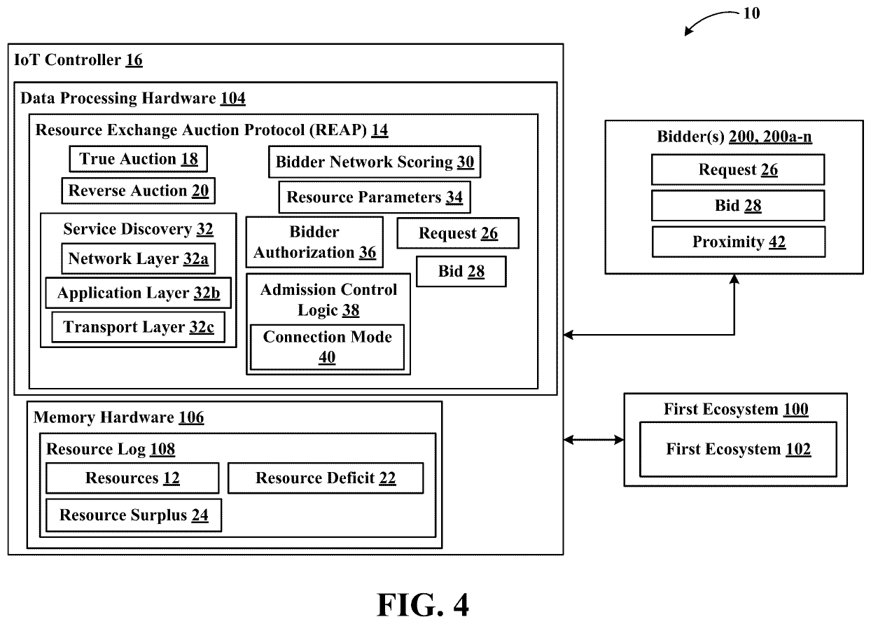

Referring now to FIGS. 2-5, the REAP 14 may be triggered by a determination of one of the resource deficit 22 and the resource surplus 24 at one of the ecosystems 100, 200 and is executed by the IoT controller 16. In some instances, the IoT controller 16 may identify that the first ecosystem 100 has a resource surplus 24 and may trigger the REAP 14 to execute the true auction 18. The true auction 18 is defined as a resource sharing transaction that is initiated by a resource donor 102 (e.g., the first ecosystem controller 102) advertising to multiple bidders 200, 200a-n requesting resources 12. In this example, the first ecosystem controller 102 may function as a donor configured to auction-off the resource surplus 24 to other ecosystems (i.e., the second ecosystem 200) that may have a resource deficit 22 through the IoT controller 16. Although described herein with respect to the first ecosystem 100 and the second ecosystem 200, it is contemplated that the REAP 14 may be executed between a plurality of ecosystems 200, 200a-n. For example, the true auction 18 may present the resource surplus 24 of the first ecosystem 100 to multiple, second ecosystems 200 that may compete to obtain the surplus resources 12.

The IoT controller 16 may receive one or more requests 26 for the resources 12 that are in surplus. For example, the request 26 may be initiated at the first ecosystem 100, where the first ecosystem 100 may be a donor or a requestor, described in more detail below. In some examples, the REAP 14 may be executed by the IoT controller 16 to advertise the resource surplus 24 to nearby ecosystems 200. For example, the second ecosystem 200, 200a-n may discover the request 26, such that the second ecosystem 200, 200a-n is the other of the donor or requestor, described herein. In a true auction 18 example, the resource surplus 24 may occur as a result of the first ecosystem 100 operating with sufficient resources 12 that meet or exceed an allocated number of resources 12 that the first ecosystem 100 has available for use by the first ecosystem 100. The resource exchange auction system 10 advantageously assists the first ecosystem 100 in sharing the unused resources 12 (i.e., the resource surplus 24) with nearby ecosystems 200 that may benefit from additional resources 12.

In other examples, the IoT controller 16 may identify that the first ecosystem 100 has a resource deficit 22, such that the first ecosystem 100 may benefit from additional resources 12. The IoT controller 16 may, thus, execute the reverse auction 20 of the REAP 14 to seek out additional resources 12. The reverse auction 20 is defined as a resource sharing transaction initiated by the requesting ecosystem 100 (e.g., the first ecosystem 100) with multiple donor ecosystems 200, 200a-n bidding to share respective resources 12. In one example of the reverse auction, the IoT controller 16 functions as a requestor configured to request resources 12 from other ecosystems 200, 200a-n. In the reverse auction 20, the REAP 14 advertises, via the request 26, that the first ecosystem 100 is looking for additional resources 12. Nearby ecosystems 200, 200a-n may receive the request 26 and may issue a bid 28 on the reverse auction 20.

For example, the first ecosystem 100 may use a high speed communication bandwidth (i.e., resource 12) with a cap of up to two-hundred (200) megabytes per second (mbps) and has reached the cap 110. The first ecosystem 100 may thus seek out additional bandwidth from ecosystems 200 that may have excess resources (i.e., a resource surplus 24). For example, a nearby ecosystem 200 may have a resource surplus 24 of fifty (50) mbps and may offer the resource surplus 24 of 50 mbps to the first ecosystem 100 in the form of the bid 28. Another ecosystem 200a may have a resource surplus 24 of one-hundred (100) mbps and may also submit a bid corresponding to 100 mbps to the first ecosystem 100. As described in more detail below, the REAP 14 is configured to compare the bids 26 before selection. In either of the true auction 18 and the reverse auction 20, a single bidder 200, 200a-n is selected by the IoT controller 16 to either share or receive the resources 12.

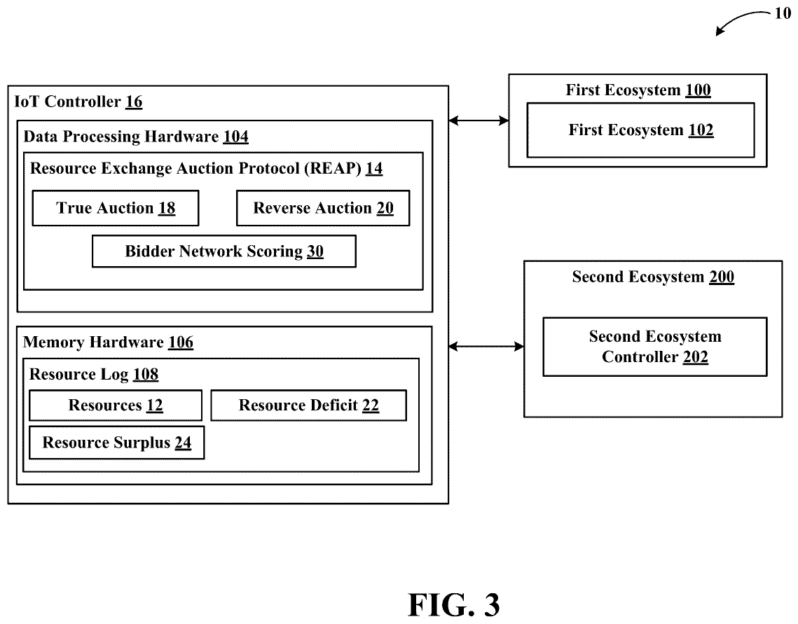

With reference to FIGS. 3-6, the REAP 14 executes a bidder network scoring 30 in response to the initiation of either of the true auction 18 or the reverse auction 20. The bidder network scoring 30 is used to rank and evaluate the various ecosystems 200, 200a-n that are either bidding on or offering resources 12. However, the term bidder(s) may be utilized in either auction 20, 22, where the bidder is the potential donor or potential receiver of the resources 12. The bidder network scoring 30 may have different criteria depending on whether the REAP 14 is executing the true auction 18 or the reverse auction 20. The REAP 14 utilizes the bidder network scoring 30 to identify the ecosystem 100, 200, 200a-n with the greatest need for the resources 12 or with the most availability of resources 12, depending on whether the REAP 14 is executing the true or reverse auction 16, 18. The bidder network scoring 30 may be a market-driven score, such that the IoT controller 16 may assess the supply and demand of the resources 12. For example, the bidder with the highest bidder network scoring 30, in the true auction 20, is the ecosystem 200, 200a-n with the greatest need for the resources. Comparatively, in the reverse auction 22, the bidder with the highest bidder network scoring 30 is the ecosystem 200, 200a-n with the greatest available resources 12. Thus, the bidder network scoring 30 provides a degree of leverage for the receiver and/or the donor (e.g., the first ecosystem 100).

The bidder network scoring 30 is based on urgency, mobility, location, availability, congestion, and energy, among other examples, for a respective bidder 200, 200a-n. For example, the first ecosystem controller 100 evaluates each application threshold and requirement to identify which bidder ecosystem 200, 200a-n is a compatible fit for the request 26. While the initiation of the REAP 14 on the IoT controller 16 may be based on either of the true auction 18 or the reverse auction 20, the REAP 14 includes the same process steps for both the true auction 18 and the reverse auction 20. As mentioned above, the REAP 14 is executed by the IoT controller 16 in response to the initiation. As described above, the initiation step depends on whether the ecosystem 100 has a resource deficit 22 or a resource surplus 24.

Once initiated, the REAP 14 discovers respective bidders (e.g., donor ecosystems 200, 200a-n or requestor ecosystems 200, 200a-n). The REAP 14 may advertise the resource state 20, 22 via a service discovery 32. The advertising by the REAP 14 may include resource parameters 34 that set forth conditions for being considered for the resource exchange transaction. For example, the REAP 14 may indicate a cost associated with the resources 12. Each of the layers 32a-32c are utilized by the service discovery 32 to identify the bidders 200, 200a-n for the auctioned resources 12. Again, it is noted that the bidders 200, 200a-n may be bidding on resources 12 (i.e., the true auction 18) or may be bidding on the opportunity to share resources 12 (i.e., the reverse auction 20).

The REAP 14 subsequently executes a bidder authorization 36 to identify the bidder 200, 200a-n with the proper criteria. The criteria may be set by the IoT controller 16 based on the available resources 12 and/or based on the resources 12 needed by the first ecosystem 100. The bidder authorization 36 is an initial clearance that ensures the bidders 200, 200a-n match the criteria and are able to proceed to selection. Thus, the bidder authorization 36 is separate from selection of a bidder 200, 200a-n.

With further reference to FIGS. 3-6, the IoT controller 16 is configured to control access to the resources 12 after authorizing the bidder(s) 200, 200a-n, such that an admission control logic 38 of the REAP 14 is executed. For example, the admission control logic 38 may execute a connection mode 40, which assesses the networks associated with the bidders 200, 200a-n and the associated score 30a from the bidder network scoring 30. In addition, the connection mode 40 may assess a proximity 42 of the bidder 200, 200a-n. It is also contemplated that the admission control logic 38 may utilize other modes to determine access for the bidders 200, 200a-n and that those mentioned herein are exemplary of the types of conditions considered for permitting access.

With respect to the score 30a of a bidder 200, 200a-n, the REAP 14 may adjust a price associated with the resources 12 in the event of a true auction 18. For example, if the score 30a is high, then the score 30a indicates that there is a higher need for the resources 12. In this example, the IoT controller 16 may increase a price or cost associated with the resource 12 to maximize the profit. Thus, the REAP 14 may be configured to identify the bidder 200, 200a-n with the highest score 30a in order to select a bidder 200, 200a-n. In the event of a reverse auction 20, the IoT controller 16 executes the admission control logic 38 to determine which donor-bidder 200, 200a-n is able to provide the most resources 12.

In some examples, the REAP 14 may provide the ability to share both tangible and intangible resources 12. For example, in a reverse auction scenario 18, if a first bidder 200, 200a is a charging ecosystem equipped with a cellular network, the first ecosystem 100 may utilize charging resources 12 and cellular network resources 12. Comparatively, a second bidder 200, 200b may offer charging resources 12, but no cellular resources. In the reverse auction 16, the IoT controller 16 may select the first bidder 200, 200a based on the number and/or type of resources 12 available. In this example, the first bidder 200, 200a would have a higher score 30a than the second bidder 200, 200b as a result of the diverse resources 12 available from the first bidder 200, 200a.

In a true auction 18 example, a first bidder 200, 200a may have a high score 30a as compared to a second bidder 200, 200a as a result of an established relationship between the first bidder 200, 200a and the first ecosystem 100. For example, the first bidder 200, 200a and the second bidder 200, 200b may have equal need or urgency for the resources 12 advertised by the IoT controller 16, but the first bidder 200, 200a has an established trust (e.g., an established, trusted entity) with the first ecosystem 100. As a result, the REAP 14 may assign a higher score 30a when executing the bidder network scoring 30 to prioritize the bidder 200, 200a with an existing relationship. The established or existing relationship may be a brand or other contractual relationship that is programmed as part of the REAP 14 or otherwise known by the IoT controller 16.

Once the bidder 200, 200a has been authenticated, assessed, and selected, the resources 12 are shared between the first ecosystem 100, via the IoT controller 16, and the bidder ecosystem 200, 200a-n. As mentioned above, a single bidder ecosystem 200, 200a-n is selected for sharing of resources between the selected bidder ecosystem 200, 200a-n and the first ecosystem 100.

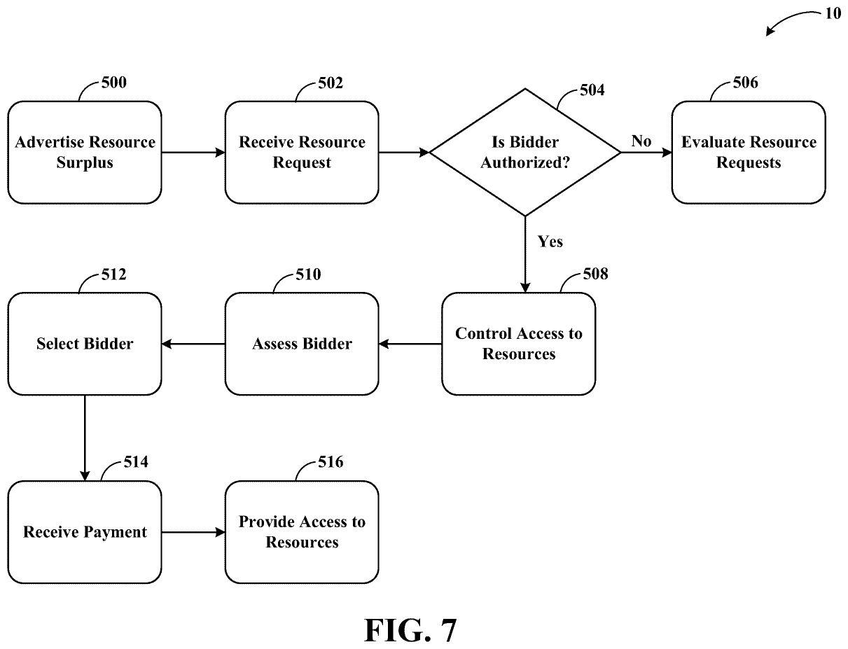

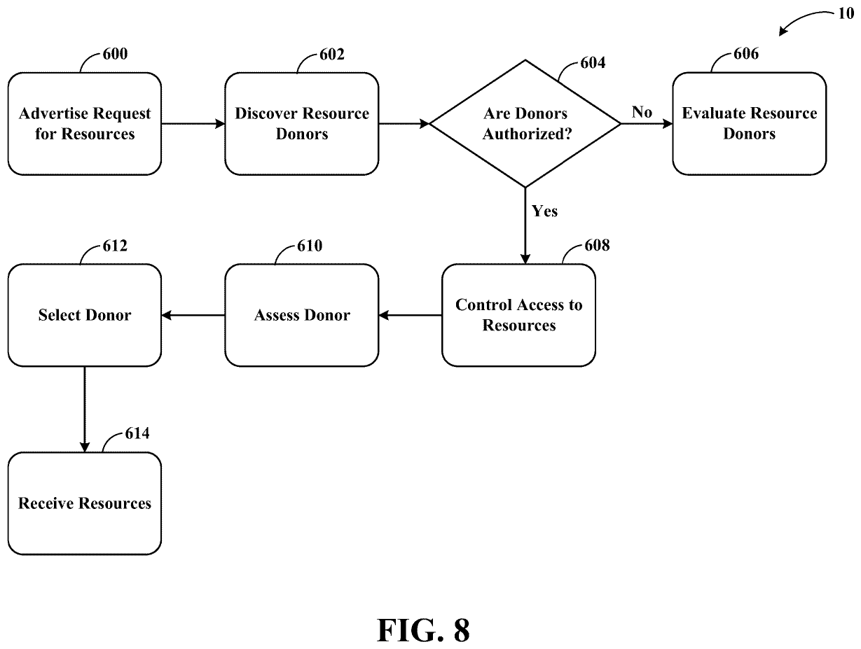

Referring now to FIGS. 7 and 8, exemplary flow diagrams of the true auction 18 (FIG. 7) and the reverse auction (FIG. 8) of the resource exchange auction system 10 are illustrated. With respect to FIG. 7, the IoT controller 16 advertises, at 500, the resources 12 as a resource surplus 24 and receives, at 502, a request 26 for resources. The REAP 14 determines, at 504, whether the bidder 200, 200a-n is authorized. If the bidder 200, 200a-n is not authorized, then the REAP 14 evaluates, at 506, other requests 26. If the bidder 200, 200a-n is authorized, then the REAP 14, at 508, controls access to the resources and assesses, at 510, the bidder 200, 200a-n. Upon completion of the assessment, the REAP 14 selects, at 512, the bidder 200, 200a-n and receives, at 514, payment for the resources 12. Once payment is complete, the IoT controller 16 provides access to the resources, at 516.

With reference to FIG. 8, the IoT controller 16 advertises, at 600, a request 26 for resources 12 and discovers, at 602, resource donor bidders 200, 200a-n. The REAP 14 determines, at 604, whether a donor bidder 200, 200a-n is authorized. If the donor bidder 200, 200a-n is not authorized, then the REAP 14 evaluates, at 606, another donor bidder 200, 200a-n. If the donor bidder 200, 200a-n is authorized, then the REAP 14 controls access to the resources 12, at 608, and assesses, at 610, the donor bidder 200, 200a-n. The IoT controller 16 may then select a donor, at 612, and receive the resources 12, at 614. In some examples, the IoT controller 16 also proceeds with a payment step in exchange for the received resources 12.

Referring again to FIGS. 1-8, the resource exchange auction system 10 advantageously assists ecosystems 100, 200, 200a-n with sharing and exchanging resources 12 to maximize the available resources 12 for a given ecosystem 100, 200, 200a-n. The REAP 14 provides the IoT controller 16 with structure to evaluate and compare bidders 200, 200a-n based on one of the resource surplus 24 and resource deficit 22 to identify a compatible fit for the resources 12 by executing the bidder network scoring 30. Further, the execution of the admission control logic 38 further helps to compare scores 30a of the bidders 200, 200a-n and set a potential payment scale based on the score 30a. Further, in some examples, the REAP 14 may advantageously assist the IoT controller 16 in prioritizing a bidder 200, 200a-n with an established relationship with the ecosystem 100, 200 associated with the IoT controller 16. Thus, all ecosystems 100, 200 may benefit from the implementation of the resource exchange system 10 by distributing unused resources 12 to ecosystems 100, 200 that may be experiencing a resource deficit 22.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
initiating, at a first ecosystem, a request, the first ecosystem being one of a donor and a requestor;
discovering, by a second ecosystem, the initiated request, the second ecosystem being the other of the donor and requestor; and
executing, at one of the first ecosystem and the second ecosystem, a resource exchange auction protocol (REAP), the REAP including:
controlling access to resources;
assessing the other of the first ecosystem and the second ecosystem;
selecting the other of the first ecosystem and the second ecosystem; and
sharing the resources of one of the first ecosystem and the second ecosystem with the other of the first ecosystem and the second ecosystem.

2. The method of claim 1, wherein assessing the other of the first ecosystem and the second ecosystem includes scoring the other of the first ecosystem and the second ecosystem with a bidder network scoring of the REAP.

3. The method of claim 1, wherein an internet-of-things (IoT) controller is configured to execute the REAP, the IoT controller in communication with a first ecosystem controller and a second ecosystem controller.

4. The method of claim 3, wherein the first ecosystem is a requestor and initiating the request includes notifying, by the IoT controller, the first ecosystem of a resource surplus of the second ecosystem.

5. The method of claim 3, wherein the first ecosystem is a donor and initiating the request includes notifying, by the IoT controller, the second ecosystem of a resource surplus of the first ecosystem.

6. The method of claim 5, wherein the IoT controller is configured to execute the REAP based on a request from the second ecosystem to access the resource surplus of the first ecosystem.

7. The method of claim 1, wherein the REAP includes admission control logic and controlling access to the resources includes executing the admission control logic.

8. The method of claim 1, wherein executing the REAP includes executing a reverse auction.

9. The method of claim 1, wherein executing the REAP includes executing a true auction.

10. A system comprising:
data processing hardware; and
memory hardware in communication with the data processing hardware, the memory hardware storing instructions that when executed on the data processing hardware cause the data processing hardware to perform operations comprising:
initiating, at a first ecosystem, a request, the first ecosystem being one of a donor and a requestor;
discovering, by a second ecosystem, the initiated request, the second ecosystem being the other of the donor and requestor; and
executing, via one of the first ecosystem and the second ecosystem, a resource exchange auction protocol (REAP), the REAP including:
controlling access to resources;
assessing the other of the first ecosystem and the second ecosystem;
selecting the other of the first ecosystem and the second ecosystem; and
sharing the resources of one of the first ecosystem and the second ecosystem with the other of the first ecosystem and the second ecosystem.

11. The system of claim 10, wherein assessing the other of the first ecosystem and the second ecosystem includes scoring the other of the first ecosystem and the second ecosystem with a bidder network scoring of the REAP.

12. The system of claim 10, wherein an internet-of-things (IoT) controller is configured to execute the REAP, the IoT controller in communication with a first ecosystem controller and a second ecosystem controller.

13. The system of claim 12, wherein the first ecosystem is a requestor and initiating the request includes notifying, by the IoT controller, the first ecosystem of a resource surplus of the second ecosystem.

14. The system of claim 12, wherein the first ecosystem is a donor and initiating the request includes notifying, by the IoT controller, the second ecosystem of a resource surplus of the first ecosystem.

15. The system of claim 14, wherein the IoT controller is configured to execute the REAP based on a request from the second ecosystem to access the resource surplus of the first ecosystem.

16. The system of claim 10, wherein the REAP includes admission control logic and controlling access to the resources includes executing the admission control logic.

17. The system of claim 10, wherein executing the REAP includes executing a reverse auction.

18. The system of claim 10, wherein executing the REAP includes executing a true auction.

19. A computer-implemented method when executed by data processing hardware causes the data processing hardware to perform operations comprising:
initiating, at a first ecosystem, a request, the first ecosystem being one of a donor and a requestor;
discovering, by a second ecosystem, the initiated request, the second ecosystem being the other of the donor and requestor; and
executing, at one of the first ecosystem and the second ecosystem, a resource exchange auction protocol (REAP), the REAP including admission control logic, executing the REAP including:
controlling access to resources via the admission control logic;
scoring the first ecosystem with a bidder network scoring of the REAP;
selecting the other of the first ecosystem and the second ecosystem; and
sharing the resources of one of the first ecosystem and the second ecosystem with the other of the first ecosystem and the second ecosystem.

20. A vehicle including a controller configured to execute the method of claim 19.
